(19) United States
(12) Patent Application Publication
(10) Pub. No.: US 2019/0193887 A1
(43) Pub. Date: Jun. 27, 2019

(54) STORAGE TROLLEY FOR PROTECTIVE COVERS

(71) Applicant: Multivac Sepp Haggenmüller SE & Co. KG, Wolfertschwenden (DE)

(72) Inventors: Christian LAU, Heimenkirch (DE); Elmar EHRMANN, Bad Grönenbach (DE)

(21) Appl. No.: 16/224,933

(22) Filed: Dec. 19, 2018

(30) Foreign Application Priority Data
Dec. 21, 2017 (EP) 17 209 311.4

(51) Int. Cl. B65B 59/04; B65B 57/00

(52) U.S. Cl. CPC B65B 59/04; F16P 1/02; B65B 57/005

(57) ABSTRACT

Storage trolley for receiving at least two protective covers of a packaging machine, preferably a thermoforming packaging machine, for example, for cleaning or maintenance purposes. The storage trolley has a plurality of movable holders for receiving protective covers of the packaging machine. The holders are moveable between a parking position and a receiving position. The storage trolley is configured to be stored below a machine frame of the packaging machine when the holders are in the parking position. The holders receive one or more protective covers in the receiving position.

### CROSS-REFERENCE TO RELATED APPLICATIONS

This Application claims priority to European Patent Application No. 17 209 311.4 filed on Dec. 21, 2017 to Christian Lau and Elmar Ehrmann, currently pending, the entire disclosure of which is incorporated herein by reference.

### FIELD OF THE INVENTION

The invention relates to a storage trolley for protective covers of a thermoforming packaging machine.

### BACKGROUND OF THE INVENTION

A tool exchange trolley for a thermoforming packaging machine for exchanging forming tools is known from DE 102008019628 A1. This tool exchange trolley can be driven into the thermoforming packaging machine, where a side panel of the packaging machine must be removed for this purpose and the frame is recessed in this region.

Generally known are thermoforming packaging machines having protective covers upstream and/or downstream of workstations, such as a forming or sealing station, in order to prevent a machine operator from reaching into the workstation. Such thermoforming packaging machines are often used in food processing plants and must be cleaned regularly. For this purpose, the protective covers, which are placed manually onto the thermoforming packaging machine, must be removed from the thermoforming packaging machine in order to obtain proper access to the regions therebeneath. For this purpose, the protective covers are often placed or stacked on the floor or on a nearby storage table. This can lead to damage that prevents the correct use on the thermoforming packaging machines. In addition, it is time consuming to move the protective covers to storage locations that are remote from the thermoforming packaging machine.

### SUMMARY OF THE INVENTION

The object of the invention is to improve the handling of the protective covers on a thermoforming packaging machine during the cleaning process.

According to the invention, the storage trolley for receiving at least two protective covers of a packaging machine, preferably a thermoforming packaging machine, is characterized in that the storage trolley has movable holders for receiving protective covers of the packaging machine, where the holders can be converted between a parking position and a receiving position, where the storage trolley can be positioned below a machine frame of the packaging machine when the holders are in the parking position. The storage trolley can be stowed directly at or under the packaging machine, respectively, and a time-consuming search for the matching storage trolley and an additional storage space for the storage trolley itself are eliminated. The protective covers received on the storage trolley can then be cleaned very easily, as well as the areas of the packaging machine which became properly accessible due to the protective covers being removed.

A “machine frame” in the context of the invention is to be understood as comprising only horizontally oriented parts of the machine frame, i.e. no supporting feet.

The holders are preferably tiltable in order to convert them in a simple manner from a substantially horizontal parking position to a substantially vertical receiving position.

An advantageous embodiment provides that the holders may be inserted and withdrawn in order to convert them in a simple manner from a substantially horizontal parking position to a substantially vertical receiving position.

In the parking position, and in one embodiment, the holders may not project beyond an upper interference contour of the storage trolley in order to allow the storage trolley to have as large an overall height as possible and still allow it to be positioned below the machine frame. The interference contour may be defined by the outer dimensions of the storage trolley. The upper interference contour of the storage trolley may be defined by the most upwardly projecting part of the storage trolley.

In a particularly advantageous configuration, at least one holder may be arranged on a holding device and the holding device may be mounted slidably on a frame of the storage trolley. This entails the advantage of greater flexibility in order to be able to change the holders in their distance from one another for being able to receive different widths of protective covers, for example, of different packaging machines.

The holders may be locked in the receiving position to be secured in a keyless manner in the receiving position.

In one embodiment, the storage trolley may have an overall height of less than 300 mm, preferably less than 200 mm, when the holders are in the parking position. The storage trolley may then also be positioned beneath frames of packaging machines which allow only such distances from the lower edge of the machine frame to the ground due to safety requirements.

In one embodiment, the storage trolley preferably does not project beyond the side frames of the packaging machine so as not to obstruct or endanger a machine operator.

Other aspects and advantages of the present invention will be apparent from the following detailed description of the preferred embodiments and the accompanying drawing figures.

### DESCRIPTION OF THE SEVERAL VIEWS OF THE DRAWINGS

In the following, an advantageous embodiment of the present invention will be explained in more detail making reference to a drawing, in which the individual figures show:

FIG. 1 is a side schematic view of one embodiment of a thermoforming packaging machine in accordance with the teachings of the present disclosure;

FIG. 2 is a perspective view of one embodiment of a storage trolley in accordance with the teachings of the present disclosure with holders in a parking position; and

FIG. 3 is a perspective view of the storage trolley of FIG. 2 showing the holders in a receiving position and holding multiple protective covers.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

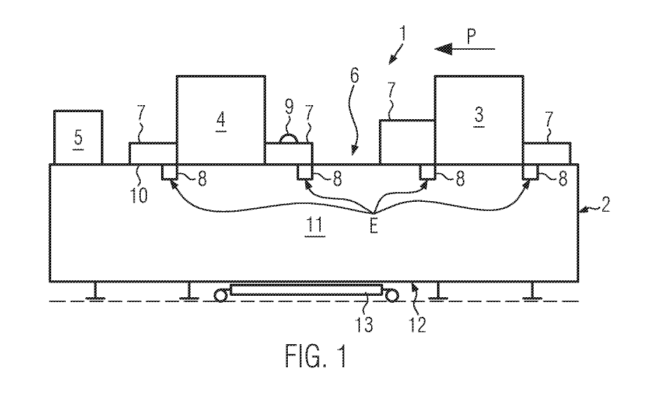

FIG. 1 shows schematically a side view of an operating side of a packaging machine 1 according to the invention which is configured as a thermoforming packaging machine. Packaging machine 1 has a machine frame 2, a forming station 3, a sealing station 4 and a cutting station 5. Forming station 3 forms trays in a base film, not shown. The trays of the base film are filled with products along a loading stretch 6. At the sealing station 4, a top film, not shown, is sealed onto the base film after the tray interior has been evacuated and/or aerated in order to increase the shelf life of, for example, food products. The packages formed in the film composite of the base and the top film are separated at the cutting station 5 and mechanically transported out of packaging machine 1 or removed manually therefrom.

Certain areas immediately upstream or downstream of forming station 3, sealing station 4 and/or cutting station 5 must be protected from an operator reaching in from above, for example, to prevent injuries when reaching into a lifting mechanism. According to FIG. 1, protective covers 7 for this purpose are positioned upstream and downstream of forming station 3 and upstream and downstream of sealing station 4. Protective covers 7 are preferably examined for their presence using a detection unit E formed on packaging machine 1, in particular by sensors 8, so that no machine start is possible in the absence of one of the protective covers 7, especially also when the latter is not properly positioned on packaging machine 1, for example, is tilted.

For maintenance, reconfiguration or cleaning purposes, protective covers 7 placed loosely on the machine frame 2 can be removed from their position. However, it is not desirable for protective covers 7 to be placed on the floor next to packaging machine 1, primarily for reasons of hygiene. In particular with packaging machine 1 cleaned on a daily basis as is common, protective covers 7 must be removed from their position to make the area therebelow accessible for cleaning. Protective covers 7 themselves should then also be positioned advantageously for cleaning.

Protective covers 7 according to FIG. 1 can be formed having different dimensions depending on the zone to be protected. The respective protective covers 7 are formed to have the same width, when viewed in the direction of production P. However, FIG. 1 indicates that respective protective covers 7, when viewed in the direction of production P, can be formed to have different depths and/or heights. Also equally sized protective covers 7 can be considered.

Protective cover 7, positioned by way of example in FIG. 1 in front of sealing station 4, has a handle 9 which facilitates an operator raising protective cover 7. Handle 9 can also be provided on the other protective covers 7 of FIG. 1.

FIG. 1 also shows that respective protective covers 7 are placed on an upper side 10 of a side frame 11 of packaging machine 1. Side frame 11 forms part of machine frame 2 of packaging machine 1.

Illustrated beneath an underside 12 of machine frame 2 or side frame 11, respectively, is a storage trolley 13 according to the invention below packaging machine 1 in its parking position.

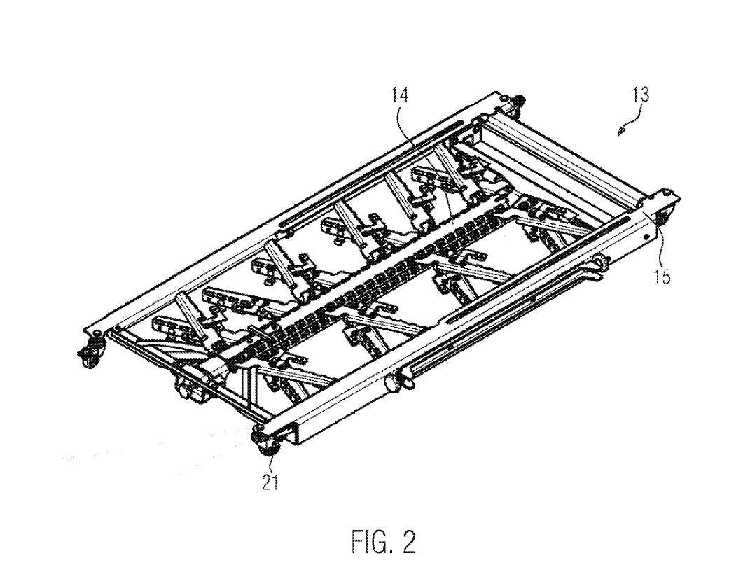

FIG. 2 shows storage trolley 13 in an illustration with holders 14 in a parking position. Holders 14 there do not project beyond storage trolley 13 or its frame 15, respectively. Disposed on frame 15 are several rotatably mounted and lockable rollers 21 for freely moving storage trolley 13 and also for locking it when loading and unloading protective covers 7.

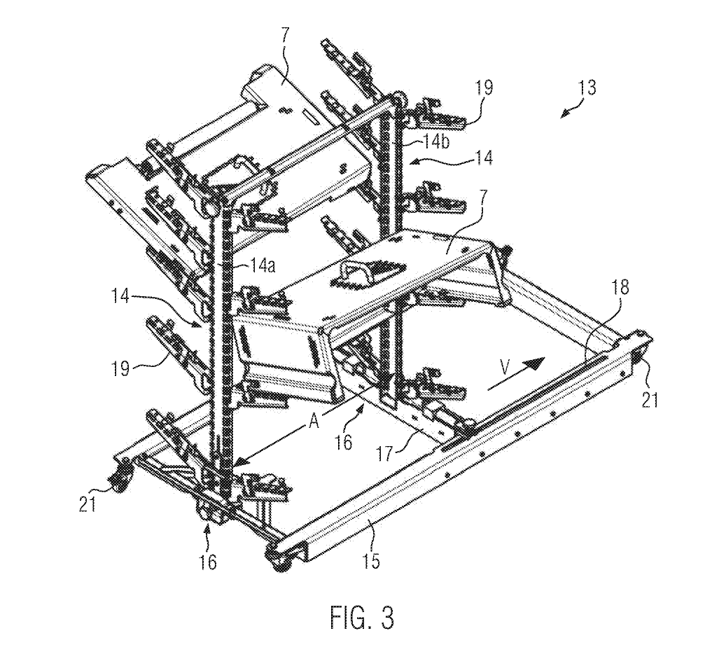

FIG. 3 shows storage trolley 13 in an illustration with holders 14 in a receiving position in which holders 14 have been raised from a horizontal position to the vertical position. Holder 14 can be pivoted about a horizontal axis, not shown, by way of a pivot bearing 16.

A first holder 14a is arranged on the left front side, while a second holder 14b is arranged farther to the right on a holding device 17. Distance A between the two holders 14a and 14b can be adjusted by way of displaceable holding device 17, which is movable along a guide, not shown in more detail, in a sliding direction V and can be clamped in a slotted device 18, such that protective covers 7 can be deposited on supports 19 of holders 14a, 14b.

Frame 15 with rollers 21 at all four corners forms the base of storage trolley 13. Holders 14 are arranged on frame 15 by way of pivot bearings 16 and/or by way of holding device 17.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A storage trolley for receiving at least two protective covers of a packaging machine, the storage trolley comprising:
a plurality of movable holders for receiving protective covers of said packaging machine, wherein said holders are moveable between a parking position and a receiving position; and wherein said storage trolley is configured for being positionable under a machine frame of said packaging machine when said holders are in the parking position.

2. A storage trolley according to claim 1, wherein said holders are tiltable.

3. A storage trolley according to claim 1, wherein said holders can be inserted and withdrawn.

4. A storage trolley according to claim 1, wherein when said holders are disposed in the parking position, said holders do not project beyond an upper interference contour of said storage trolley.

5. A storage trolley according to claim 1, wherein at least one of said holders is disposed on a holding device and said holding device is slidably mounted on a frame of said storage trolley.

6. A storage trolley according to claim 1, wherein said holders can be locked in the receiving position.

7. A storage trolley according to claim 1, wherein said storage trolley has an overall height of less than 300 mm when said holders are disposed in the parking position.

8. A storage trolley according to claim 1, wherein said storage trolley has a first width that is less than a second width of said machine frame of said packaging machine so that said storage trolley does not project laterally beyond one or more sides of said machine frame of said packaging machine.
